(19) United States
(12) Patent Application Publication
(10) Pub. No.: US 2026/0237882 A1
(43) Pub. Date: Aug. 13, 2026

(54) ANTENNA MOUNTING DEVICE

(71) Applicant: John Rayfield, SR., Springfield, MO (US)

(72) Inventor: John Rayfield, SR., Springfield, MO (US)

(21) Appl. No.: 19/535,632

(22) Filed: Feb. 10, 2026

Related U.S. Application Data
(60) Provisional application No. 63/757,591, filed on Feb. 12, 2025.

(51) Int. Cl. H01Q 1/20

(52) U.S. Cl. CPC H01Q 1/20

(57) ABSTRACT

An antenna mounting device may include a tower mount assembly that may be coupled to an antenna mount assembly. The tower mount assembly may include a first support arm coupled to a base. The first support arm may include a first angled surface and a second angled surface that may be angled relative to each other. A guide post may be coupled to the base so that the guide post and the first support arm are positioned on opposite sides of the base. The guide post may have a distal end, and a guide plate may be coupled to the guide post. The antenna mount assembly may include a receiver plate, and a post receiver coupled to the receiver plate. The antenna mount assembly may be configured to be engaged to the tower mount assembly by mating the distal end of the guide post with the post receiver.

### CROSS REFERENCE TO RELATED APPLICATIONS

This application claims priority to and the benefit of the filing date of U.S. Provisional Application No. 63/757,591, filed on Feb. 12, 2025, entitled “ANTENNA MOUNTING DEVICE”, which is hereby incorporated by reference in its entirety.

### FIELD OF THE INVENTION

This patent specification relates to the field of antenna mounting devices. More specifically, this patent specification relates to antenna mounting devices for mounting antennas and/or other equipment to towers.

### BACKGROUND

While devices and methods for mounting and attaching antennas to objects, such as tower structures, exist, these existing devices and methods mounting antennas consist of multiple brackets and other pieces as well as large numbers of bolts, washers and nuts. Because of the number of pieces involved, it is time consuming to mount these on the tower and adjust them for the proper positioning on the tower. Often, much of this assembly and adjustment of parts must be done by the installer on the tower, increasing the time that the installer must be on tower. This can become a safety issue in some cases.

Therefore, a need exists for novel antenna mounting devices which do not suffer from the drawbacks of existing devices and methods for mounting and attaching antennas to objects.

### BRIEF SUMMARY OF THE INVENTION

An antenna mounting device is provided. Preferably, the device provides a means of quickly attaching and detaching an antenna or any other object to tower structures that are designed to hold such antennas, and preferably the device can also be used to install other equipment that is often connected to antennas and to a tower.

In some embodiments, the device may include a tower mount assembly that may be coupled to an antenna mount assembly. The tower mount assembly may have a base to which one or more, such as two, support arms may be coupled to, and the support arms may be configured to contact a tower or other object that the device and an antenna or other object are to be coupled to. The base and support arms may comprise one or more apertures which may receive fasteners that may be used to couple a tower mount adjustment plate and/or to couple the device to tower, or other object. A guide post may be coupled to the base so that the guide post and support arms may be positioned on opposite sides of the base, and a guide plate may be coupled to the guide post. The antenna mount assembly may include a post receiver that may have a post aperture that may be sized and shaped to receive a portion of the guide post. A receiver plate and one or more mounting plates may be coupled to the post receiver. The mounting plates may comprise one or more apertures which may receive fasteners that may be used to couple an antenna or other object to the mounting plates, and the tower mount assembly and antenna mount assembly may be coupled together by inserting the guide post into the post aperture and by coupling the guide plate to the receiver plate via one or more fasteners.

In further embodiments, the device may include a tower mount assembly that may be removably coupled to an antenna mount assembly. The tower mount assembly may include a base, and a first support arm may be coupled to the base. The first support arm may include a first angled surface and a second angled surface, and the first angled surface may be angled relative to the second angled surface. A guide post may be coupled to the base so that the guide post and the first support arm are positioned on opposite sides of the base. The guide post may have a distal end that may be distal to the base, and a guide plate may be coupled to the guide post. The antenna mount assembly may include a receiver plate, and a post receiver may be coupled to the receiver plate. The antenna mount assembly may be configured to be engaged to the tower mount assembly by mating the distal end of the guide post with the post receiver.

Numerous objects, features and advantages of the present invention will be readily apparent to those of ordinary skill in the art. Some example objects of the present invention are listed below.

One object of the present invention is to provide an antenna mounting device which allows the installation of antennas on a tower leg that has a Safety-Climb attached, without interfering with climbing or the use of the Safety-Climb.

Another object is to provide an antenna mounting device which allows much of the assembly as well as mounting the antenna to the antenna mount assembly to be able to be done on the ground when using the antenna mounting device. Assembling anything on the ground is much faster and safer than doing so while supported on a tower by climbing gear.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a perspective view of an example of an antenna mounting device according to various embodiments described herein.

FIG. 2 depicts a top plan view of an example of an antenna mounting device according to various embodiments described herein.

FIG. 3 depicts a sectional, through line 3 -3 shown in FIG. 2, elevation view of an example of an antenna mounting device according to various embodiments described herein.

FIG. 4 illustrates a perspective view of another example of an antenna mounting device according to various embodiments described herein.

FIG. 5 depicts a top plan view of another example of an antenna mounting device according to various embodiments described herein.

FIG. 6 depicts a sectional, through line 6 -6 shown in FIG. 5, elevation view of another example of an antenna mounting device according to various embodiments described herein.

FIG. 7 illustrates a top perspective view of an example of a tower mount assembly according to various embodiments described herein.

FIG. 8 illustrates a bottom perspective view of an example of a tower mount assembly according to various embodiments described herein.

FIG. 9 illustrates a rear elevation view of an example of a tower mount assembly according to various embodiments described herein.

FIG. 10 illustrates a perspective view of an example of an antenna mount assembly according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

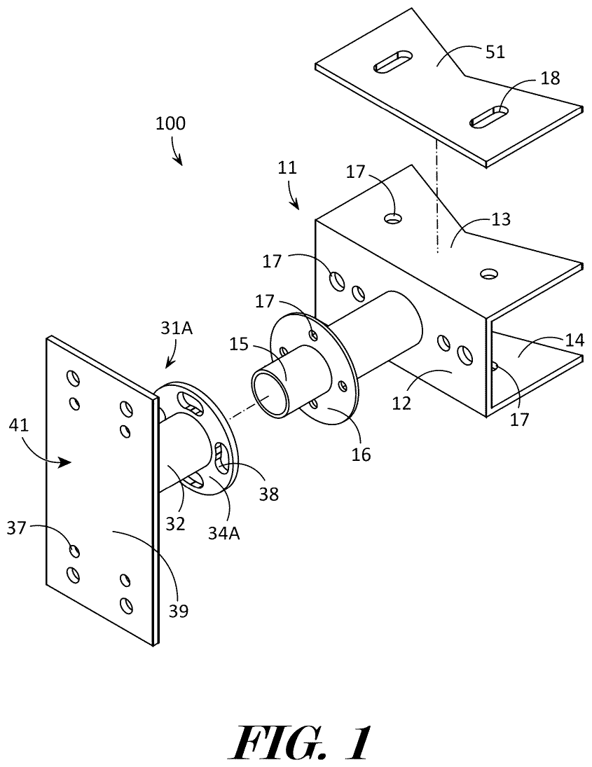

For purposes of description herein, the terms “upper,” “lower,” “left,” “right,” “rear,” “front,” “side,” “vertical,” “horizontal,” and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first,” “second,” etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 20% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

A new antenna mounting device is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

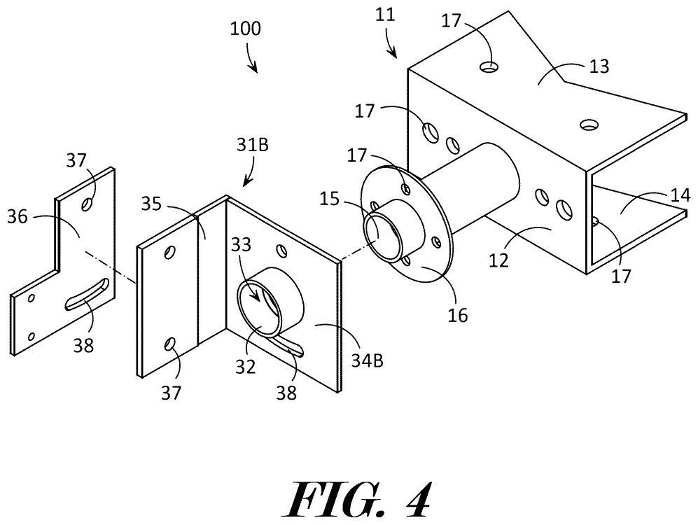

The present invention will now be described by example and through referencing the appended figures representing preferred and alternative embodiments. FIGS. 1 and 4 illustrate examples of an antenna mounting device (“the device”) 100 according to various embodiments. In some embodiments, the device 100 may comprise a tower mount assembly 11 and an antenna mount assembly 31A, 31B, that may be removably coupled together. A tower mount assembly 11 may comprise a base 12 to which one or more support arms 13, 14, may be coupled to, and the one or more support arms 13, 14, may be configured to contact a tower or other object that the device 100 and an antenna or other object are to be coupled to. The base 12 and support arms 13, 14, may comprise one or more fastener apertures 17 which may receive fasteners, e.g., bolts, nuts, screws, rivets, etc., that may be used to couple a tower mount adjustment plate 51 and/or to couple the device 100 to tower, or other object. A guide post 15 may be coupled to the base 12 so that the guide post 15 and support arms 13, 14, may be positioned on opposite sides of the base 12. The guide post 15 may have a distal end 25 that is distal to the base 12. A guide plate 16 may be coupled to the guide post 15. A receiver plate 34A, 34B, and one or more mounting plates 35, 36, 39, may be coupled to the post receiver 32. The mounting plates 35, 36, 39, may comprise one or more fastener apertures 37 and/or elongated apertures 38, which may receive fasteners that may be used to couple an antenna or other object to the mounting plates 35, 36, 39. The tower mount assembly 11 and antenna mount assembly 31A, 31B, may be engaged together by mating the distal end 25 of the guide post 15 with the post receiver 32, optionally by inserting the guide post 15 into the post aperture 33. The tower mount assembly 11 and antenna mount assembly 31A, 31B, may be coupled together by coupling the guide plate 16 to the receiver plate 34A, 34B, via one or more fasteners, e.g., bolts, nuts, screws, rivets, etc.

A tower mount assembly 11 may comprise a base 12, and one or more support arms, such as a first support arm 13 and a second support arm 14, may be coupled to the base 12. A base 12 may be configured in any size and shape, such as a rectangular shape. Preferably, two support arms 13, 14, may be coupled to the base 12 so that the support arms 13, 14, are generally parallel to each other, and so that the base 12 and support arms 13, 14, may form a generally U-shaped bracket. In preferred embodiments, a first support arm 13 and a second support arm 14 may be separated from each other by a base channel 26. A base channel 26 may be configured in any size and shape in order to separate a first support arm 13 and a second support arm 14 a desired distance.

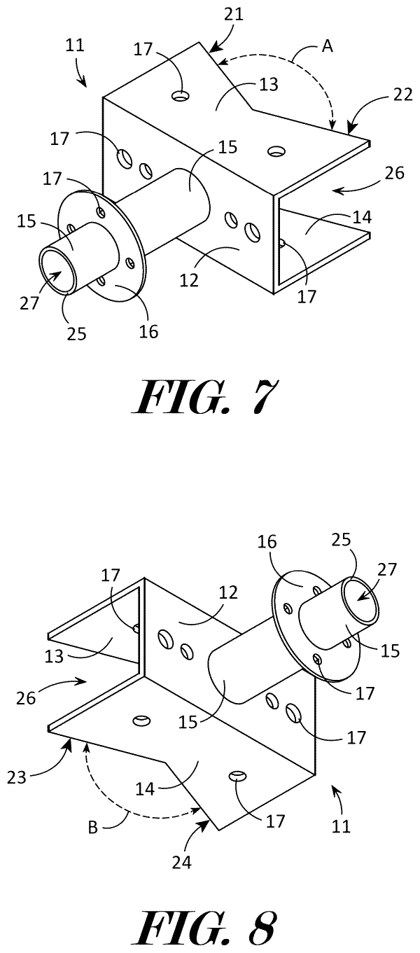

Support arms 13, 14, may be configured in any shape and size. Preferably, support arms 13, 14, may comprise two or more angled surfaces which may be configured to contact a tower or other object that the device 100 and an antenna or other object are to be coupled to, and the angled surfaces may be angled towards each other to facilitate centering of the antenna or other object on the support arms 13, 14. In some embodiments, the device 100 may comprise a first support arm 13 having a first angled surface 21 and a second angled surface 22, and the first angled surface 21 may be angled relative to the second angled surface 22 as shown by Angle A in FIG. 7. Preferably, Angle A may be between 45 and 179 degrees, and more preferably between 100 and 170 degrees. In some embodiments, the device 100 may comprise a second support arm 14 having a third angled surface 23 and a fourth angled surface 24, and the third angled surface 23 may be angled relative to the fourth angled surface 24 as shown by Angle B in FIG. 8. Preferably, Angle B may be between 45 and 179 degrees, and more preferably between 100 and 170 degrees.

In some embodiments, the device 100 may comprise a tower mount adjustment plate 51 which may be coupled to the tower mount assembly 11, such as to a support arm 13, 14. A tower mount adjustment plate 51 may be configured in any shape and size. Preferably, a tower mount adjustment plate 51 may comprise two or more angled surfaces which may be configured to contact a tower or other object that the device 100 and an antenna or other object are to be coupled to, and the angled surfaces may be angled towards each other to facilitate centering of the antenna or other object on the tower mount adjustment plate 51. By coupling a tower mount adjustment plate 51 to a support arm 13, 14, the tower mount adjustment plate 51 is able to extend further from the front of the base 12 and can be used to allow for using the device 100 on tapered or straight towers, making it easier to align the antenna properly on different types of towers (such as self-supporting or guyed towers). So if a tower is tapered (self-supporting towers and guyed towers are typically larger at the bottom and taper to a small size at the top, so the each leg of the tower is at an angle with reference to perfectly horizontal), by coupling a tower mount adjustment plate 51 to a support arm 13, 14, the tower mount adjustment plate 51 allows the base 12 to be vertical and not sloped/angled and also preferably allowing the guide post 15 to extend away from the tower in a horizontal level direction and not be not sloped/angled.

In some embodiments, the device 100 may comprise one or more guide posts 15 that may be coupled to a base 12. A guide post 15 may be coupled to the base 12 so that the guide post 15 and support arms 13, 14, may be positioned on opposite sides of the base 12 and so that the guide post 15 and support arms 13, 14, extend away from each other in generally opposing directions. A guide post 15 may be configured in any size and shape. Preferably, a guide post 15 may comprise a cylindrical shape. Preferably, a guide post 15 may be elongated in shape so as to have an elongated length, and the elongated length may separate a distal end 25 from the base 12. Generally, the distal end 25 of the guide post 15 may be distal to the base 12 such that the distal end 25 may form the end or portion of the guide post 15 that is positioned farthest from the base 12. Preferably, the distal end 25 may be cylindrical in shape.

One important feature of the guide post 15 is that it allows the antenna mount assembly 31A, 31B, to be positioned and held in place without the installer having to hold it, with ground personnel holding the weight of the antenna mount assembly 31A, 31B. This allows the installer to have both hands free to attach the antenna mount assembly 31A, 31B, to the tower mount assembly 11.

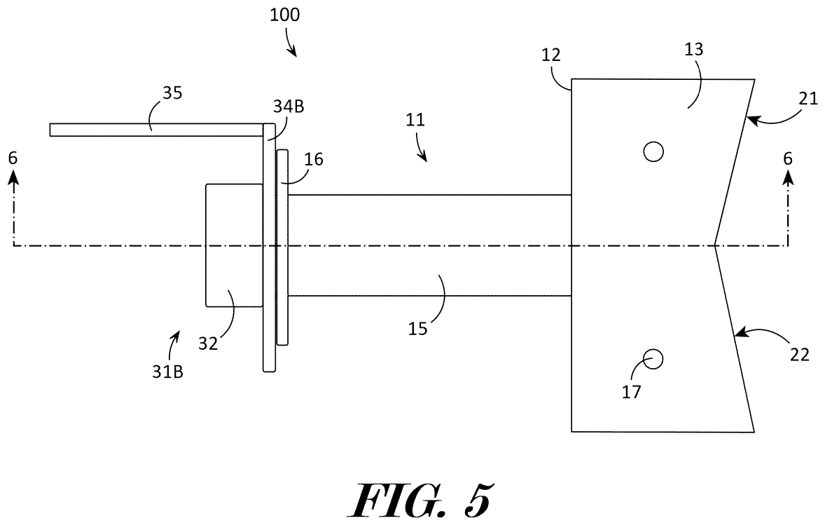

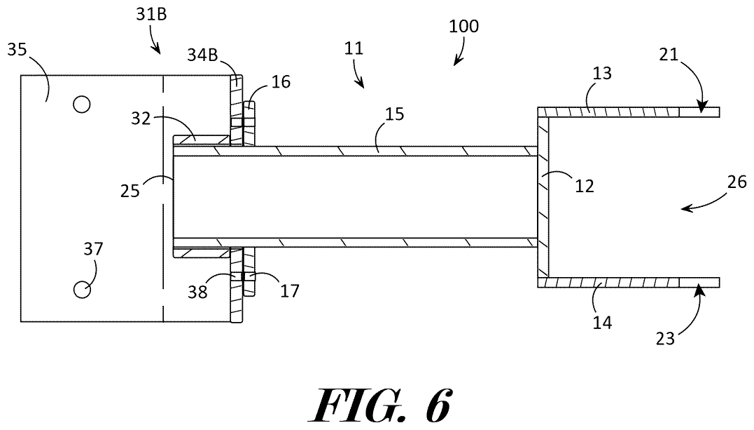

The device 100 may comprise a guide plate 16 that may be coupled to the guide post 15. Preferably, a guide plate 16 may be coupled to the guide post 15 so that the guide plate 16 is positioned between the distal end 25 of the guide post 15 and the base 12. A guide plate 16 may be configured in any shape and size. Preferably, a guide plate 16 may extend around all or a portion of the guide post 15. In some embodiments, a guide plate 16 may comprise a circular or annular shape that may encircle the guide post 15. In preferred embodiments, a guide plate 16 may comprise a generally flat or planar shape, such as a flat or planar annular shape. In further embodiments, the device 100 may comprise a guide post 15 that may be elongated in length, and the guide plate 16 may be substantially perpendicular (plus or minus 5 degrees) to the elongated length of the guide post 15 as perhaps best shown in FIG. 1-8.

In some embodiments, the base 12, support arms 13, 14, and guide plate 16 may comprise one or more fastener apertures 17. In preferred embodiments, the base 12 and support arms 13, 14, may comprise one or more, such as a plurality of, fastener apertures 17 that may be sized and shaped to receive fasteners that may be used to couple the device 100 to tower, or other object. For example, the tower mount assembly 11 may comprise fastener apertures 17 which may enable the tower mount assembly 11 to be coupled to a tower using only two u-bolts, four washers and four nuts. Optionally, a guide plate 16 may comprise one or more elongated apertures, similar to elongated apertures 38 and/or elongated apertures 18.

In preferred embodiments, one or more support arms 13, 14, may comprise one or more fastener apertures 17 which may receive fasteners that may be used to couple a tower mount adjustment plate 51 to a support arm 13, 14. Preferably, a tower mount adjustment plate 51 may comprise one or more elongated apertures 18 which may enable adjustability of the tower mount adjustment plate 51 relative to the support arm 13, 14, that it is coupled to via one or more fasteners. Compared to a circular or cylindrical aperture, an elongated aperture 18 may be elongated to allow a round or cylindrical fastener, such as a bolt, to be positioned at different locations within the elongated aperture 18 which may enable adjustability of the tower mount adjustment plate 51 relative to the support arm 13, 14, that it is coupled to via the round or cylindrical fastener. In preferred embodiments, a guide plate 16 may comprise one or more fastener apertures 17 which may receive fasteners that may be used to couple the guide plate 16 to a receiver plate 34A, 34B.

The device 100 may comprise an antenna mount assembly 31A, 31B, that may be configured to couple an antenna or other object to the receiver plate 34A, 34B. In some embodiments, the antenna mount assembly 31A, 31B, may be configured to be engaged to the tower mount assembly 11 by mating the guide post 15 with the post receiver 32. In preferred embodiments, the antenna mount assembly 31A, 31B, may be configured to be engaged to the tower mount assembly 11 by mating the distal end 25 of the guide post 15 with the post receiver 32.

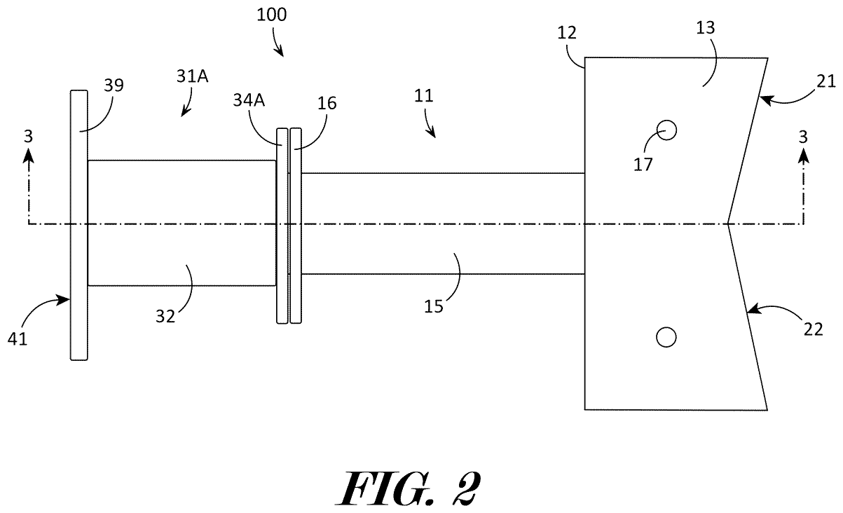

In some embodiments, an antenna mount assembly 31A, 31B, may comprise a post receiver 32 that may have a post aperture 33 that may be sized and shaped to receive a portion of the distal end 25 of the guide post 15, and the guide post 15 may be mated with the post receiver 32 by inserting a portion of the guide post 15, such as a the distal end 25, into the post aperture 33 of the post receiver 32 as perhaps best shown in FIGS. 2, 3, 5, and 6. A post receiver 32 and a post aperture 33 may be configured in any size and shape. In preferred embodiments, a post receiver 32 and a post aperture 33 may be configured in a shape that is commentary to the shape of a guide post 15 so that a portion of the guide post 15 may be received in the post aperture 33 of the post receiver 32. Preferably, a post receiver 32 and a post aperture 33 may be configured with a cylindrical shape. In alternative embodiments, a guide post 15 may be mated with the post receiver 32 by inserting a portion of the post receiver 32 into a guide aperture 27 of the guide post 15.

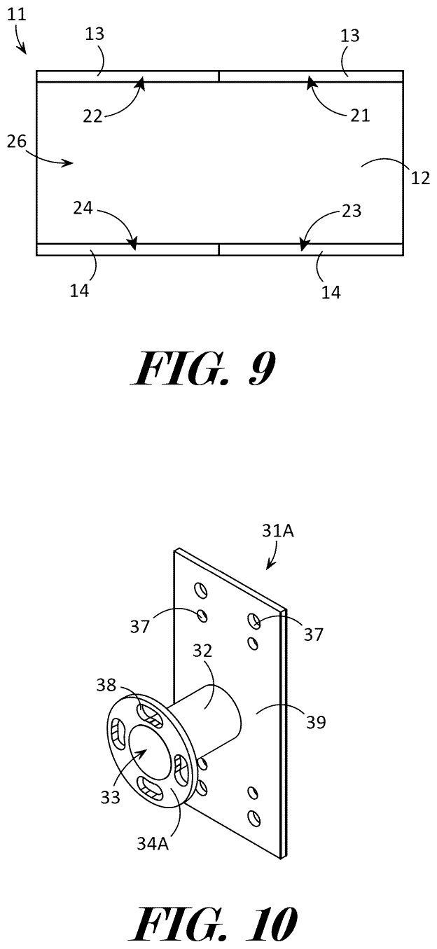

An antenna mount assembly 31A, 31B, may comprise a receiver plate 34A, 34B, which may be coupled to a post receiver 32. In preferred embodiments, once the distal end 25 of the guide post 15 is mated with the post receiver 32, the guide plate 16 of a tower mount assembly 11 may be coupled to a receiver plate 34A, 34B, in order to couple the tower mount assembly 11 to the antenna mount assembly 31A, 31B. A receiver plate 34A, 34B, may be configured in any shape and size. In some embodiments, and as perhaps best shown in FIGS. 1 and 9, a receiver plate 34A may comprise an annular or ring shape. In some embodiments, and as perhaps best shown in FIG. 4-6, a receiver plate 34B may comprise a rectangular shape.

A receiver plate 34A, 34B, may comprise one or more fastener apertures 37 and/or one or more elongated apertures 38. Preferably, a receiver plate 34A, 34B, may comprise one or more, such as a plurality of, fastener apertures 37 that may be sized and shaped to receive fasteners that may be used to couple the receiver plate 34A, 34B, to a guide plate 16. For example, the receiver plate 34A, 34B, may comprise fastener apertures 37 which may enable the receiver plate 34A, 34B, to be coupled to the guide plate 16 using cylindrical fasteners, such as bolts, screws, etc.

Preferably, a receiver plate 34A, 34B, may comprise one or more elongated apertures 38 which may enable adjustability of the positioning of the receiver plate 34A, 34B, relative to the guide plate 16 and guide post 15 when the receiver plate 34A, 34B, is coupled to the guide plate 16 via one or more fasteners. Compared to a circular or cylindrical aperture, an elongated aperture 38 may be elongated to allow a round or cylindrical fastener, such as a bolt, to be positioned at different locations within the elongated aperture 38 which may enable adjustability of the tower mount receiver plate 34A, 34B, relative to the guide plate 16 that it is coupled to via the round or cylindrical fastener.

The device 100 may comprise one or more mounting plates 35, 36, 39, which may form the portion of the antenna mount assembly 31A, 31B, to which an antenna may be attached. Mounting plates 35, 36, 39, may be configured in any size and shape to accept multiple sizes of mounting pipes, both in diameter and length. Vertical or horizontal mounting antenna positions can be achieved by rotation of the antenna mount assembly 31A, 31B, relative to the tower mount assembly 11. Different configurations of the antenna mount assembly 31A, 31B, to allow for the device 100 to support a wide range of different types and sizes of antennas and other equipment. By constructing the elements of the mounting plates 35, 36, 39, with different thicknesses of metal, or other substantially rigid materials, as needed, as well as using different sizes of the antenna mount assembly 31A, 31B, and tower mount assembly 11, an even wider range of different antennas and other equipment can be used with the device 100, while retaining the same functionality-an ability which makes this antenna mounting device 100 so unique.

A first example of an antenna mount assembly 31A is shown in FIG. 1-3 and 9. In this and some embodiments, an antenna mount assembly 31A may comprise a receiver plate 34A and a terminal mounting plate 39 that may each be coupled to a post receiver 32. In preferred embodiments, the receiver plate 34A and terminal mounting plate 39 may be coupled to opposite ends of the post receiver 32. For example, the device 100 may comprise a receiver plate 34A that may be coupled to a first end of a cylindrical post receiver 32 and a terminal mounting plate 39 may be coupled to a second end of the cylindrical post receiver 32. The receiver plate 34A may be configured in any shape and size, such as an annular or ring shape, and may comprise one or more elongated apertures 38 which may enable adjustability of the receiver plate 34A relative to the guide plate 16 that it is coupled to via one or more fasteners (and therefore allow adjustability of the antenna mount assembly 31A relative to the tower mount assembly 11 that it is coupled to.

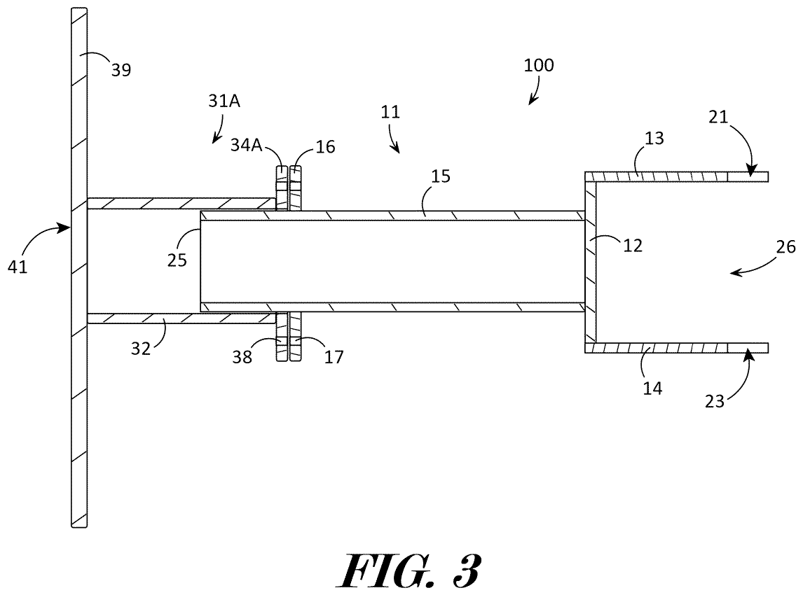

A terminal mounting plate 39 may be configured in any size and shape, such as a rectangular shape, and may comprise one or more, such as a plurality of, fastener apertures 37 which may receive fasteners that may be used to couple an antenna or other object to the terminal mounting plate 39. Preferably, a terminal mounting plate 39 may comprise a flat or planar shape, such as a flat or planar rectangular prism shape. In some embodiments, a terminal mounting plate 39 may comprise a terminal mounting surface 41 that may form the portion of the terminal mounting plate 39 that is most distal to the receiver plate 34A. Preferably, a terminal mounting surface 41 may be flat or planar in shape, the device 100 may have a guide post 15 that is elongated in length, and the terminal mounting surface 41 may be substantially perpendicular to the elongated length of the guide post 15 when the distal end 25 of the guide post 15 is mated with the post receiver 32 as perhaps best shown in FIGS. 2 and 3.

A second example of an antenna mount assembly 31B is shown in FIG. 4-7. In this and some embodiments, an antenna mount assembly 31B may comprise a receiver plate 34B that may be coupled to a first end of a cylindrical post receiver 32 and a lateral mounting plate 35 may be coupled to receiver plate 34B. The receiver plate 34B may be configured in any shape and size, such as a rectangular shape, and may comprise one or more fastener apertures 37 and elongated apertures 38 which may enable adjustability of the receiver plate 34B relative to the guide plate 16 that it may be coupled to via one or more fasteners (and therefore allow adjustability of the antenna mount assembly 31B relative to the tower mount assembly 11 that it is coupled to.

A lateral mounting plate 35 may be configured in any size and shape, such as a rectangular shape, and may comprise one or more fastener apertures 37 which may receive fasteners that may be used to couple an antenna, an auxiliary mounting plate 36, other object to the lateral mounting plate 35. A lateral mounting plate 35 may be coupled to any portion of the receiver plate 34B, preferably by being coupled to a perimeter edge of the receiver plate 34B. In preferred embodiments, the lateral mounting plate 35 and the receiver plate 34B may each be planar in shape, and the lateral mounting plate 35 may be substantially perpendicular (plus or minus 5 degrees) to the receiver plate 34B.

In some embodiments, the device 100 may comprise an auxiliary mounting plate 36 which preferably may be coupled to a lateral mounting plate 35. An auxiliary mounting plate 36 may be configured in any size and shape. Preferably, an auxiliary mounting plate 36 may be generally flat or planar in shape and/or “L” shaped. In some embodiments, an auxiliary mounting plate 36 may comprise one or more fastener apertures 37 which may receive fasteners that may be used to couple an antenna, a lateral mounting plate 35, and other objects to the auxiliary mounting plate 36. In some embodiments, an auxiliary mounting plate 36 may comprise one or more elongated apertures 38 which may enable adjustability of the auxiliary mounting plate 36 relative to a lateral mounting plate 35 that it may be coupled to via one or more fasteners and therefore allow adjustability of an antenna coupled to the auxiliary mounting plate 36 relative to the tower mount assembly 11 that it is coupled to.

While some exemplary shapes and sizes have been provided for elements of the device 100, it should be understood to one of ordinary skill in the art that the base 12, support arms 13, 14, guide post 15, guide plate 16, other elements of the tower mount assembly 11, post receiver 32, receiver plate 34A, 34B, mounting plates 35, 36, 39, other elements of the antenna mount assembly 31A, 31B, tower mount adjustment plate 51, and any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Additionally, while some materials have been provided, in other embodiments, the elements that comprise the device 100 may be made from or may comprise durable materials such as aluminum, steel, other metals and metal alloys, wood, hard rubbers, hard plastics, fiber reinforced plastics, carbon fiber, fiberglass, resins, polymers or any other suitable materials including combinations of materials. Additionally, one or more elements may be made from or may comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. An antenna mounting device, the device comprising:
a tower mount assembly, the tower mount assembly comprising:
i. a base;
ii. a first support arm coupled to the base, wherein the first support arm comprises a first angled surface and a second angled surface, and wherein the first angled surface is angled relative to the second angled surface;
iii. a guide post coupled to the base so that the guide post and the first support arm are positioned on opposite sides of the base, the guide post having a distal end, wherein the distal end is distal to the base;
iv. a guide plate coupled to the guide post; and
an antenna mount assembly, the antenna mount assembly comprising:
i. a receiver plate; and
ii. a post receiver coupled to the receiver plate, wherein the antenna mount assembly is configured to be engaged to the tower mount assembly by mating the distal end of the guide post with the post receiver.

2. The device of claim 1, wherein the post receiver comprises a post aperture, and wherein the distal end of the guide post is mated with the post receiver by inserting the distal end of the guide post into the post aperture.

3. The device of claim 2, wherein the distal end of the guide post is cylindrical in shape.

4. The device of claim 2, wherein the post aperture is cylindrical in shape.

5. The device of claim 1, wherein the guide plate is coupled to the guide post so that the guide plate is positioned between the distal end of the guide post and the base.

6. The device of claim 1, wherein the guide post is elongated in length, and wherein the guide plate is substantially perpendicular to the elongated length of the guide post.

7. The device of claim 1, wherein the receiver plate comprises an elongated aperture.

8. The device of claim 1, further comprising a terminal mounting plate that is coupled to the post receiver.

9. The device of claim 8, wherein the receiver plate and terminal mounting plate are coupled to opposite ends of the post receiver.

10. The device of claim 8, wherein the terminal mounting plate comprises a terminal mounting surface that is planar in shape, wherein the guide post is elongated in length, and wherein the terminal mounting surface is substantially perpendicular to the elongated length of the guide post when the distal end of the guide post is mated with the post receiver.

11. The device of claim 8, wherein the terminal mounting plate comprises a plurality of fastener apertures.

12. The device of claim 1, further comprising a lateral mounting plate that is coupled to the receiver plate.

13. The device of claim 12, wherein the lateral mounting plate is planar in shape, wherein the receiver plate is planar in shape, and wherein the lateral mounting plate is substantially perpendicular to the receiver plate.

14. The device of claim 1, further comprising a second support arm coupled to the base, wherein the second support arm comprises a third angled surface and a fourth angled surface, and wherein the third angled surface is angled relative to the fourth angled surface.

15. The device of claim 14, wherein the first support arm and the second support arm are separated from each other by a base channel.

16. An antenna mounting device, the device comprising:
a tower mount assembly, the tower mount assembly comprising:
i. a base;
ii. a first support arm coupled to the base, wherein the first support arm comprises a first angled surface and a second angled surface, and wherein the first angled surface is angled relative to the second angled surface;
iii. a second support arm coupled to the base, wherein the second support arm comprises a third angled surface and a fourth angled surface, wherein the third angled surface is angled relative to the fourth angled surface, and wherein the first support arm and the second support arm are separated from each other by a base channel;
iv. a guide post coupled to the base so that the guide post and the first support arm are positioned on opposite sides of the base, the guide post having a distal end, wherein the distal end is distal to the base;
v. a guide plate coupled to the guide post; and
an antenna mount assembly, the antenna mount assembly comprising:
i. a receiver plate; and
ii. a post receiver coupled to the receiver plate, wherein the antenna mount assembly is configured to be engaged to the tower mount assembly by mating the distal end of the guide post with the post receiver.

17. The device of claim 16, wherein the post receiver comprises a post aperture, and wherein the distal end of the guide post is mated with the post receiver by inserting the distal end of the guide post into the post aperture.

18. The device of claim 16, wherein the guide post is elongated in length, and wherein the guide plate is substantially perpendicular to the elongated length of the guide post.

19. The device of claim 16, further comprising a terminal mounting plate that is coupled to the post receiver, wherein the terminal mounting plate comprises a terminal mounting surface that is planar in shape, wherein the guide post is elongated in length, and wherein the terminal mounting surface is substantially perpendicular to the elongated length of the guide post when the distal end of the guide post is mated with the post receiver.

20. The device of claim 16, further comprising a lateral mounting plate that is coupled to the receiver plate, wherein the lateral mounting plate is planar in shape, wherein the receiver plate is planar in shape, and wherein the lateral mounting plate is substantially perpendicular to the receiver plate.
